(19) United States
(12) Patent Application Publication
(10) Pub. No.: US 2022/0381387 A1
(43) Pub. Date: Dec. 1, 2022

(54) A Docking System For The Hydraulic Connection Between An Operating Unit And One Or More Mobile Service Units, With A Floating Support Device

(71) Applicant: Comau S.p.A., Grugliasco (torino) (IT)

(72) Inventors: Apostolos Fysikopoulos, Attika (GR); Mauro Maestri, Grugliasco (torino) (IT)

(21) Appl. No.: 17/773,726

(22) PCT Filed: Nov. 3, 2020
(86) PCT No.: PCT/IB2020/060298

§ 371 Date: May 2, 2022

(30) Foreign Application Priority Data
Nov. 4, 2019 (IT) 102019000020246

(51) Int. Cl. F16L 37/52; F16L 37/56

(52) U.S. Cl. CPC F16L 37/52; F16L 37/56; B25J 9/1664

(57) ABSTRACT

A docking system useful to connect and place in communication a first operating unit (3) including one or more fluid accumulators and at least one second mobile service unit (7) carrying fluid in a reservoir for refilling the accumulators. The operating unit and the at least one second mobile service unit each include hydraulic connectors carried by a floating support connected to a float supporting device to facilitate alignment and connection of the hydraulic connectors. In one example, the docking system includes a stationary intermediate structure (5) to indirectly connect and communicate the hydraulic connectors of the operating unit and the second mobile service unit. In one example, the at least one second mobile service unit is an automated guided vehicle or an autonomous mobile robot.

### CROSS-REFERENCE TO RELATED APPLICATIONS

This application is filed pursuant to 35 USC 371 claiming priority benefit to PCT/IB2020/060298 filed Nov. 3, 2020, which claims priority benefit to Italian Patent Application No. 102019000020246 filed Nov. 4, 2019, the contents of both applications incorporated herein by reference in their entirety.

### TECHNICAL FIELD

The present invention refers to a docking system for the hydraulic connection between an operating unit and one or more mobile service units.

### BACKGROUND

In the international patent application WO 2019/097372 A1, the Applicant proposed an operating unit for dispensing an adhesive or sealant fluid, configured to be carried by a robot, and including one or more fluid accumulators, which are refillable without the need to remove them from the operating unit. This known solution envisages the possibility of refilling the fluid accumulator arranged on board the operating unit carried by a robot with a refilling reservoir carried on board an autonomous vehicle (for example an AGV or an AMR). In an industrial plant equipped with a plurality of robots provided with respective operating units of the type described above, one or more autonomous vehicles are used as service vehicles to bring one or more refilling reservoirs adjacent to a robot whose operating unit has an empty fluid accumulator that needs to be refilled.

According to the known solution previously proposed by the same Applicant, when an autonomous vehicle carrying a refilling reservoir arrives at an operating unit having a fluid accumulator to be refilled, it is necessary to proceed with a docking operation between the hydraulic connectors, respectively carried by the operating unit to be refilled and the autonomous vehicle carrying the refilling reservoir. In a fully automated system, however, difficulty is encountered in ensuring that the docking operation is performed correctly and successfully, despite any inaccuracies in positioning the autonomous vehicle with respect to the operating unit and, in particular, without the risk of losing time due to the need to reposition the autonomous vehicle correctly with respect to the operating unit to be refilled.

### SUMMARY

The object of the present invention is to resolve the aforesaid problem in a simple and reliable way.

In particular, the invention relates to a docking system including a first operating unit carrying one or more hydraulic connectors and at least one second mobile service unit, carrying one or more hydraulic connectors which can be coupled, directly or indirectly, with the hydraulic connectors of the first operating unit. In one example, the invention relates to a system for docking between a first operating unit equipped with a fluid accumulator and at least one second mobile service unit equipped with a reservoir for refilling the fluid accumulator carried by the first operating unit.

In the present description, and in the following claims, the term “AGV” intends to indicate self-driving vehicles that require the provision of an infrastructure, for example, in the form of magnetic strips on the floor, or navigation beacons for driving the vehicle along a predetermined path. On the other hand, the term “AMR” refers to self-driving vehicles that instead move using a navigation system and a processor that are on board the robot. AMRs are able to perceive the environment in which they move and make decisions based on what they perceive and how they have been programmed, for example, stopping, departing again, and maneuvering around obstacles that they encounter along their path. For the purposes of the present invention, any type of autonomous vehicle can be used, being understood that the invention is applicable using a mobile unit of any type as a second mobile service unit, for example, also a manually-operated carriage or a motorized vehicle equipped with a driver's seat, such as a lifting truck. Nor is the case excluded wherein the second mobile service unit is moved by any handling device, for example, also by a manipulator robot.

In order to achieve the aforesaid object, the invention relates to a docking system of a first operating unit carrying one or more hydraulic connectors and of at least one second mobile service unit, carrying one or more hydraulic connectors, which can be coupled directly or indirectly with the hydraulic connectors of the first operating unit, wherein at least one of said hydraulic connectors is carried by the respective unit by means of a float supporting device configured to allow a floating movement of a floating support, which is mounted on the respective unit, so that the floating support is free to move relative to this along first and second directions (x, y), which are orthogonal to each other and which are also orthogonal to an axial coupling direction of the hydraulic connectors, and

wherein a respective centering member is associated with said floating support of one of said units, said centering member being configured to be coupled with a cooperating centering member directly or indirectly associated with the other of said units,

in such a way that, in a docking condition between the first operating unit and the second mobile service unit, coupling between said centering members causes a flotation of said floating support into a position that corresponds to the correct coupling position of said hydraulic connectors,

wherein said floating support is movably mounted relative to a main support along said first and second directions (x, y),

wherein said floating support is elastically biased towards a neutral position by means of a plurality of helical springs mutually angularly spaced apart, and arranged radially around said main support, each helical spring having a radially inner end associated with said main support, and a radially outer end associated with said floating support. Each of said helical springs is coaxially mounted around a guide rod, which has one end pivotally connected to either said main support or floating support, and the other end sliding in a pivotally connected cylinder to the other of said main support and floating support.

In one example, the floating support is movably mounted with respect to the main support along said first and second directions by means of two respective slides orthogonal to each other and mounted in succession on one another.

According to a further characteristic of the preferred embodiment, the docking system according to the invention further comprises a stationary intermediate structure for docking said first operating unit with said second mobile service unit. The stationary intermediate structure carries at least one hydraulic connector on its first side, which can be coupled with a hydraulic connector of the first operating unit, and at least one hydraulic connector on its second side, which can be coupled with a hydraulic connector of the second mobile service unit. The hydraulic connectors provided on the two sides of said stationary intermediate structure are also in hydraulic communication with each other.

In the case of this embodiment, therefore, the coupling between the hydraulic connectors of the first operating unit and the second mobile service unit is carried out indirectly, by coupling the hydraulic connectors of the first operating unit with the hydraulic connectors carried on the first side of the stationary intermediate structure, and coupling the hydraulic connectors of the second mobile service unit with the hydraulic connectors carried on the second side of the stationary intermediate structure.

In an embodiment example, wherein the first operating unit is carried by a manipulator robot and the second mobile service units are autonomous vehicles carrying a reservoir for refilling the fluid accumulators with which the first operating unit is equipped, the docking maneuver is carried out at the aforesaid stationary intermediate structure. The manipulator robot carries its first operating unit close to said stationary intermediate structure in such a way as to obtain the coupling of the hydraulic connectors of the first operating unit with the hydraulic connectors arranged on the first side of the stationary intermediate structure. At the same time, the autonomous vehicles stop adjacent to the second side of the stationary intermediate structure, in such a way as to obtain the coupling of the hydraulic connectors carried by the autonomous vehicles, with the hydraulic connectors arranged on the second side of the stationary intermediate structure. Each of the aforesaid coupling maneuvers takes place by exploiting the mutual engagement of centering members, which consequently determine a correct positioning of the hydraulic connectors, made possible by the respective floating supports.

Each floating support may be of the type described above, configured to be free to move in the two aforesaid x and y directions. However, in some cases, the hydraulic connector carried by the floating support is also slidably mounted with respect to the floating support in the aforesaid coupling axial direction (z) by means of a plurality of guide rods distributed angularly around the coupling axis (z). Springs are also provided to counteract an axial movement of the hydraulic connector with respect to the floating support, in the form of helical springs each associated with a respective guide rod. In this way, the hydraulic connector is also free to have a small oscillation movement with respect to its floating support around said first and second directions (x, y), corresponding to a different degree of compression of the aforesaid axial helical springs.

Furthermore, in some cases the main support on which the floating support is mounted is, in turn, mounted on the respective unit with the possibility of rotation around a vertical axis, against the action of at least two contrast springs.

In the case of the preferred embodiment, on the first side of the stationary intermediate structure, two first hydraulic connectors are provided, for independently supplying two different fluids; these connectors are carried by two first float supporting devices on a common plate, which is, in turn, mounted on said stationary intermediate structure by means of a further floating support. Each of said first floating supports is configured to be free to move both in said first and second direction, and in said axial coupling direction. The aforesaid further floating support is also configured to be free to only move in said first and second directions (x, y).

Still in the case of the aforesaid embodiment, the aforesaid common plate, on which the first two hydraulic connectors are mounted by means of said first float supporting devices, also carries at least two centering pins with conical heads protruding from said first side of the stationary intermediate structure and configured to be received within cooperating centering bushings carried by said first operating unit, in a docking condition, wherein said first hydraulic connectors carried by the stationary intermediate structure are coupled with two third hydraulic connectors carried by the first operating unit.

Again in the case of the aforesaid preferred embodiment, on the aforesaid second side of the stationary intermediate structure there are two second hydraulic connectors, hydraulically communicating with said first hydraulic connectors arranged on the first side of the stationary intermediate structure. Said second hydraulic connectors are carried on the stationary intermediate structure by means of respective floating supports configured to be free to move only in said axial coupling direction.

Still in the aforesaid preferred embodiment, two second mobile service units carrying respective hydraulic connectors configured to couple with said second hydraulic connectors arranged on the second side of the stationary intermediate structure can be provided. Each of the hydraulic connectors of the mobile units is carried by a floating support mounted on the respective unit and configured to be free to move both in said first and second direction (x, y), and in said axial coupling direction (z) with respect to a main support, which is, in turn, mounted on the respective second mobile service unit with the possibility of rotation around a vertical axis, against the action of at least two contrast springs. The floating support device carried by each of said second mobile service units also carries at least one centering pin with a tapered head protruding from the respective second mobile service unit and configured to be received within a cooperating centering bushing carried by said stationary intermediate structure on the second side thereof.

Of course, the invention is achievable in a variety of alternative embodiments. The first operating unit may not be carried by a manipulator robot, but by any other type of machine for moving the first operating unit. The example with pairs of hydraulic connectors for independently supplying two different fluids refers, in particular, to the case of an operating unit designed to dispense a two-component adhesive, which is therefore equipped with at least two hydraulic accumulators for the two components of the adhesive, which therefore require the intervention of two autonomous vehicles carrying two respective refilling reservoirs. In principle, the floating support provided according to the disclosures of the present invention can be arranged for any or both of the hydraulic connectors, which must be coupled together. Again in principle, the aforesaid stationary intermediate structure can be omitted and a docking maneuver with direct coupling between the hydraulic connectors carried by the first operating unit and the second mobile service unit can be provided.

### BRIEF DESCRIPTION OF THE DRAWINGS

Further characteristics and advantages of the invention will become apparent from the description that follows with reference to the attached drawings, provided purely by way of non-limiting example, wherein:

FIG. 1 is a schematic perspective view illustrating an industrial cell wherein a manipulator robot carrying an operating unit for dispensing a two-component adhesive is arranged, and a pair of autonomous vehicles carrying fluid reservoirs for refilling the fluid carried by the aforesaid operating unit, by means of the docking system of the present invention.

FIG. 2 is a perspective view showing the stationary structure arranged in the filling station and the two autonomous vehicles, illustrated in schematic form and in a position close to the stationary structure.

FIG. 3 illustrates the same components of FIG. 2 in a coupling condition of the hydraulic connectors carried by the two autonomous vehicles with hydraulic connectors carried on one side of the stationary structure of the filling station.

FIG. 4 is a perspective view corresponding to that of FIG. 1, which illustrates the two autonomous vehicles with their hydraulic connectors connected to the hydraulic connectors on one side of the stationary structure of the filling station, and the robot positioned in such a way as to couple the hydraulic connectors carried by the operating unit onboard the robot, with the hydraulic connectors carried on one side of the stationary structure, opposite to that to which the two autonomous vehicles are coupled.

FIG. 5 is another perspective view of the stationary structure of the filling station that, on one side, carries the hydraulic connectors intended to be coupled with the hydraulic connectors of the operating unit carried by the robot (which is not illustrated in FIG. 5), and that carries, on the opposite side, hydraulic connectors that are shown in the condition of coupling with the hydraulic connectors carried by the two autonomous vehicles.

FIG. 6 is a partial perspective view on an enlarged scale of the detail of the coupling between the hydraulic connectors of the operating unit carried by the robot and the hydraulic connectors arranged on one side of the stationary structure of the filling station.

FIG. 7 is a perspective view of a component of the assembly illustrated in the FIG. 6.

FIGS. 8A, 8B show a front view, in two different operating conditions, of a floating support forming part of the docking system according to the invention.

FIGS. 9A, 9B illustrate two alternate perspective views of a hydraulic connector and floating support assembly forming part of the docking system according to the invention.

FIG. 10 is a side view of the assembly of FIGS. 9A, 9B.

FIGS. 11A, 11B illustrate two alternate perspective views of another hydraulic connector and floating support assembly forming part of the docking system according to the invention.

FIG. 12 is a perspective view of the frame of the stationary structure forming part of the docking system according to the invention.

FIG. 13 is a partial perspective view on an enlarged scale showing the coupling of a hydraulic connector assembly and centering element carried by an autonomous vehicle, with the stationary structure forming part of the docking system according to the invention.

FIG. 14 is a further partial perspective view on an enlarged scale of the stationary structure with the hydraulic connectors associated therewith and of the two autonomous vehicles with their respective hydraulic connectors in the coupled condition with the hydraulic connectors arranged on one side of the stationary structure.

FIGS. 15A, 15B are two perspective views of a detail of a hydraulic connector and floating support assembly carried by each of the autonomous vehicles.

### DETAILED DESCRIPTION

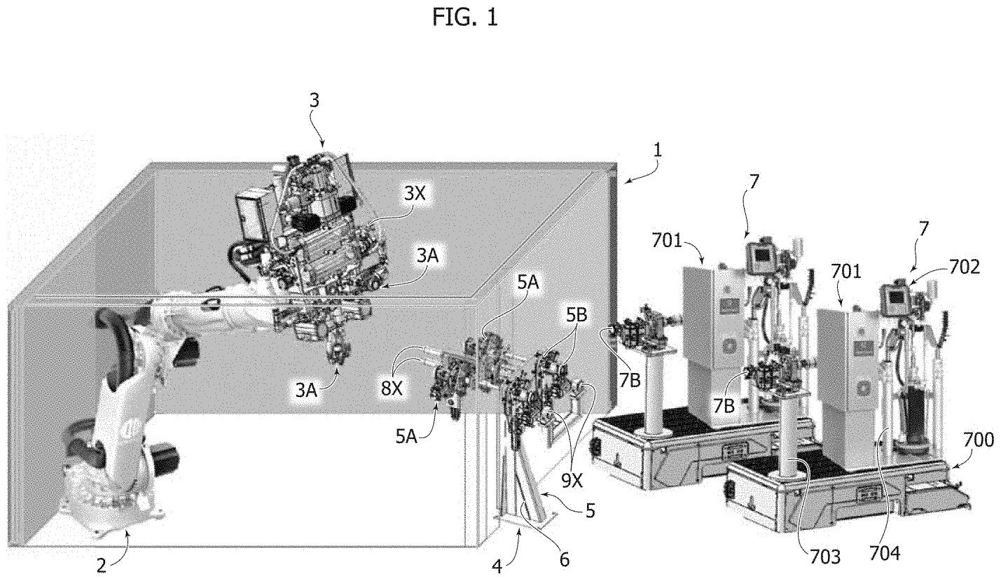

In FIG. 1, the reference number 1 indicates, in its entirety, a cell 1 of an industrial plant wherein a multi-axis manipulator robot 2, of any known type, is provided, carrying an operating unit 3 for dispensing a two-component adhesive, and for its application on components (not shown) of a structure to be assembled in cell 1. For example, the cell 1 may be a cell for assembling motor-vehicle structures. In an industrial plant, several cells of the type illustrated here can be provided, each with one or more robots 2 carrying respective operating units 3.

In the case of the specific application of the invention illustrated here, the operating unit 3 is made in accordance with the disclosures of the international patent application WO 2019/097372 A1 by the same Applicant. In accordance with this solution, the operating unit 3 carries one or more adhesive accumulators, so that it can operate autonomously, without a permanent connection, with a stationary double-sided adhesive reservoir, as instead occurs in the case of traditional solutions.

In the case of the example illustrated here, which refers to the application of a two-component adhesive, on the operating unit 3, there are two adhesive accumulators which, when finished, must be refilled with the fluids constituting the two required components.

For this purpose, a refilling station 4 including a stationary structure 5 is arranged in a peripheral area of the cell 1.

The stationary structure 5, which in the illustrated example includes an upright 6 fixed to the floor of the cell, carries hydraulic connectors 5A on one of its sides (which will be illustrated in detail below), configured to couple with hydraulic connectors 3A carried by the operating unit 3, and communicating with the adhesive accumulators arranged on board the operating unit 3.

On its opposite side, the stationary structure 5 carries hydraulic connectors 5B communicating with the hydraulic connectors 5A, and configured to couple with the hydraulic connectors 7B carried on board two autonomous vehicles 7 (e.g., second mobile service units).

Each of the autonomous vehicles 7 may be an AGV or AMR vehicle of any known type. In the preferred embodiment, the autonomous vehicles 7 are vehicles of the AMR type configured to move around the industrial plant according to any predetermined program, in response to predetermined commands, without the need to provide infrastructures in the plant for guiding the movement of vehicles 7.

With reference to the example illustrated in FIG. 1, each vehicle 7 comprises, in a per se known manner, a vehicle body 700 movable on wheels, which are at least partly motorized wheels, and steering or pivoting wheels with motorized control of the steering angle. On the body 700 of each vehicle 7 there is a reservoir 701 containing the respective component fluid, as well as a man-machine interface 702, which can be used by an operator to control the refilling operation. On the body 700 of each vehicle 7 there is an upright 703 carrying the respective hydraulic connector 7B, which communicates with the reservoir 701 through a duct 704.

Of course, the aforesaid description of the autonomous vehicles 7 and of the components carried thereon is provided purely by way of non-limiting example.

When it is necessary to refill the adhesive accumulators carried by the operating unit 3, the robot 2 is commanded to bring the operating unit 3 near the side of the refilling station 4 facing the inside of the cell, while the autonomous vehicles 7 are commanded to position themselves near the side of the refilling station 4 facing outwards. The docking operation involves the coupling of the hydraulic connectors 3A of the operating unit 3 with the hydraulic connectors 5A of the stationary structure 5, and the coupling of the hydraulic connectors 7B of the respective autonomous vehicle with the hydraulic connectors 5B of the stationary structure 5. The coupling is obtained, in the example illustrated, by means of a movement of the operating unit 3, controlled by the robot 2, towards an inner side of the stationary structure 5, and by means of the movement of the autonomous vehicles 7, towards an outer side of the stationary structure 5. The coupling is guided by the engagement of centering pins with conical heads 8X protruding from the inner side of the stationary structure 5, within a centering member, for example centering bushings 3X, carried by the operating unit 3.

Similarly, the coupling of the hydraulic connectors 5B on the outer side of the stationary structure 5 with the hydraulic connectors 7B carried by the autonomous vehicles 7 is assisted by the engagement of centering pins with conical heads protruding from the assemblies of hydraulic connectors 7B (not visible in the FIG. 1) within respective centering bushings 9X carried on the outer side of the stationary structure 5.

In a typical embodiment of the industrial cell 1, the work area inside the cell 1 is protected by enclosures (not illustrated) arranged along walls of the cell. The stationary structure 5 is arranged in such a way as to have its inner side carrying the hydraulic connectors 5A protruding inside an enclosure, and its outer side, carrying the hydraulic connectors 5B, located outside the enclosure. In this way, the working environment of the robot 2 is totally protected, for the safety of the operators moving around the industrial plant.

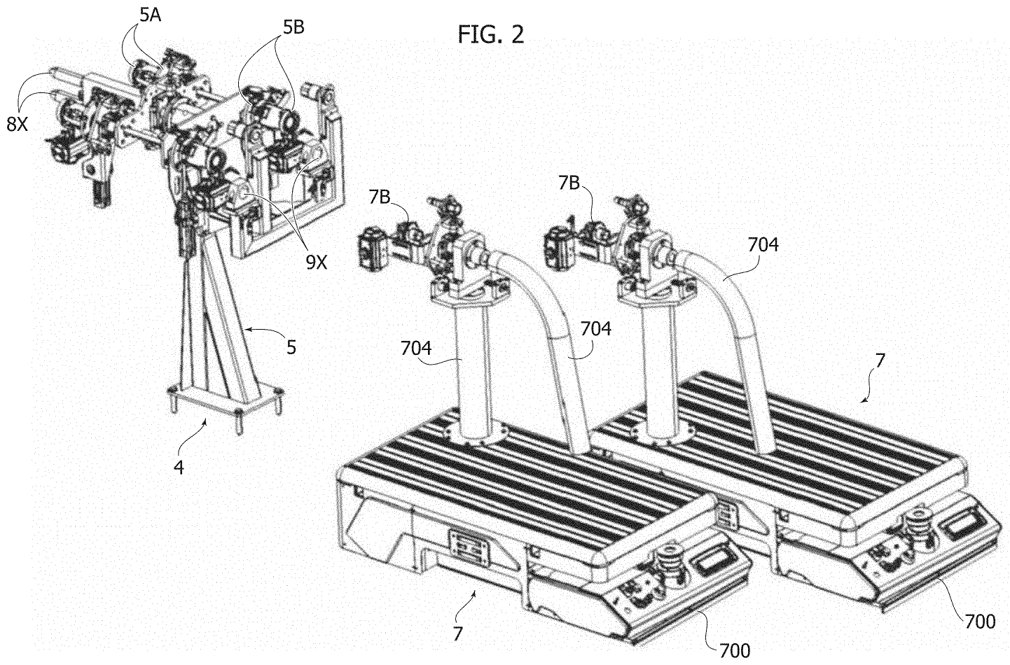

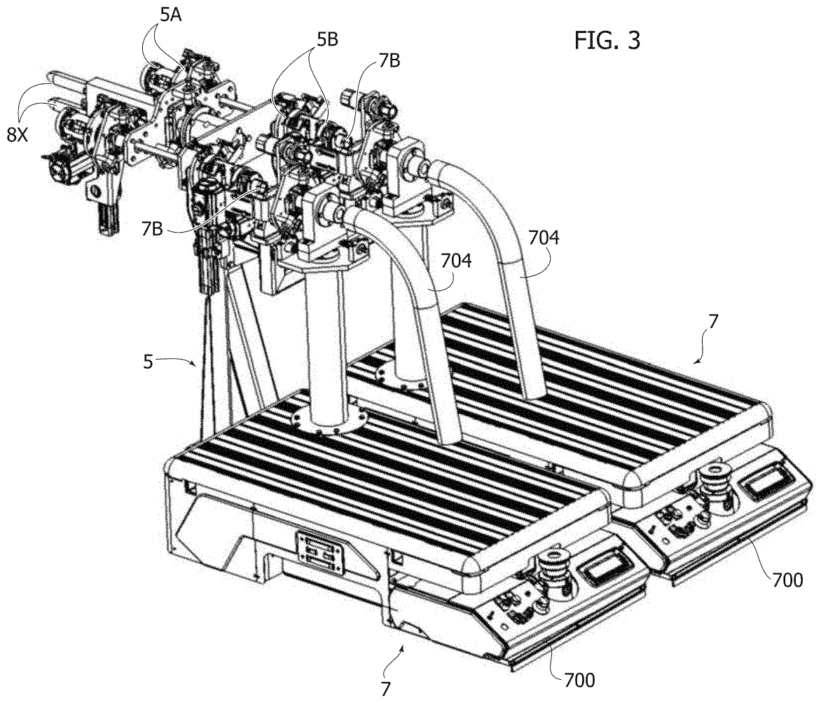

FIGS. 2, 3 show a step wherein the two autonomous vehicles 7 are adjacent to the outer side of the refilling station 4 (FIG. 2), and a step wherein the autonomous vehicles 7 have reached the final docking position (FIG. 3), wherein the hydraulic connectors 7B carried by the autonomous vehicles 7 are coupled with the hydraulic connectors 5B carried on the outer side of the stationary structure 5.

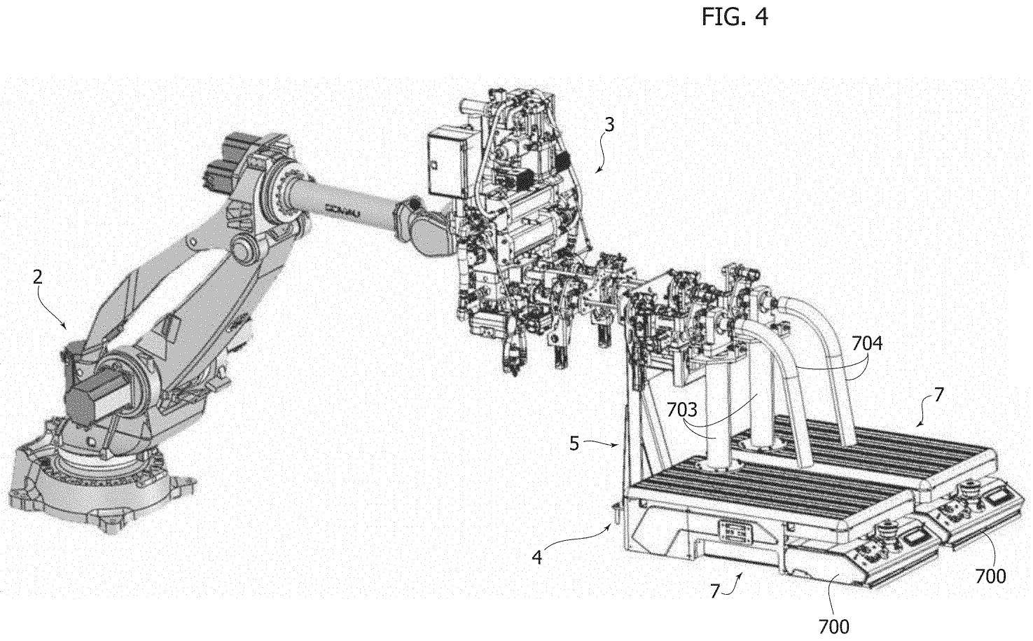

FIG. 4 is a perspective view illustrating the condition of complete docking, wherein, after the coupling of the hydraulic connectors 7B carried by the autonomous vehicles 7 with the hydraulic connectors 5B carried on the outer side of the stationary structure 5, the robot 2 has carried the operating unit 3 in the condition of coupling of the hydraulic connectors 3A carried by the operating unit 3 with the hydraulic connectors 5A carried on the inner side of the stationary structure 5. In the docking condition illustrated in FIG. 4, once the hydraulic coupling between hydraulic connectors has been ensured (in the way that will be described in detail below), the operation of transferring fluid from the reservoirs 701 (not shown in FIG. 4) carried by the vehicles 7 to the fluid accumulators arranged on the operating unit 3 can be activated. Once this operation is completed, the robot 2 can uncouple the operating unit 3 from the stationary structure 5 of the refilling station 4 to return to perform its work cycle. At the same time, the vehicles 7 can be decoupled from the outer side of the stationary structure 5 of the refilling station 4 to move to other areas of the plant and serve other cells 1 of the plant.

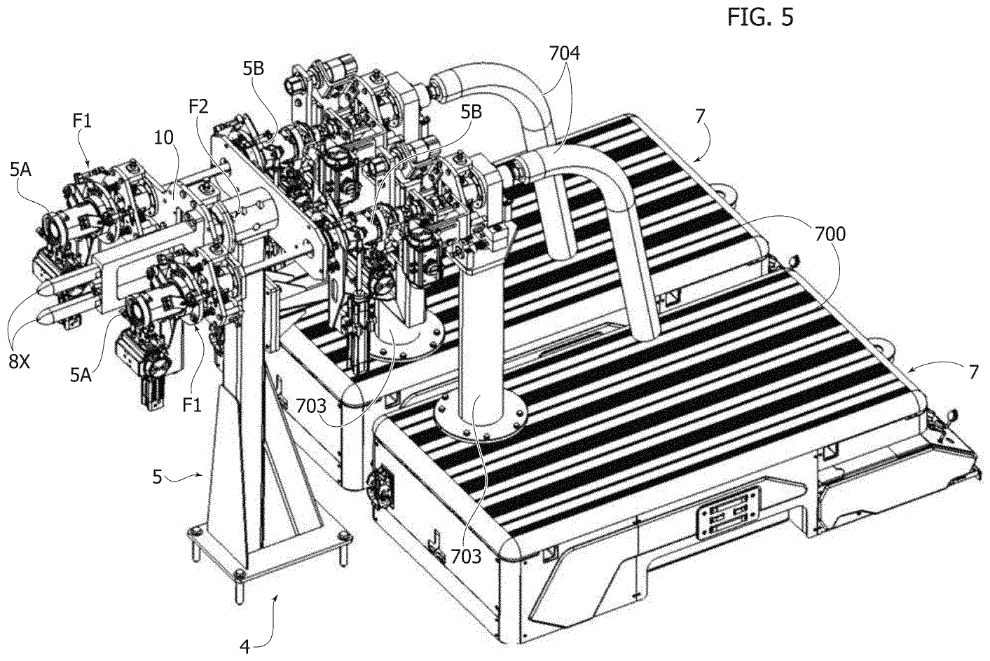

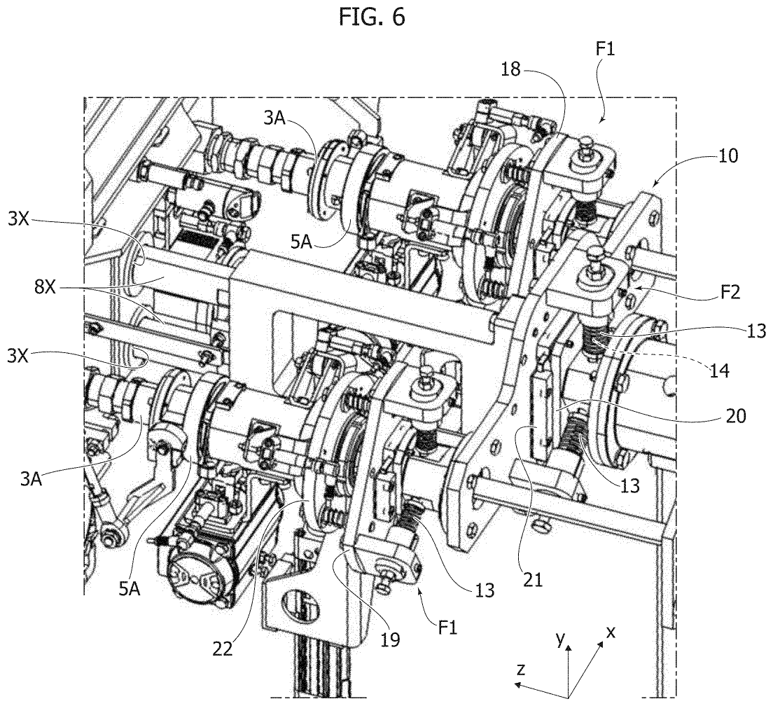

FIG. 5 is another perspective and enlarged-scale view of the refilling station 4, with the stationary structure 5 carrying the two hydraulic connectors or first hydraulic connectors 5A on one side (on the inner side or robot side) and the two hydraulic connectors or second hydraulic connectors 5B on its opposite side or outer side for connection with hydraulic connectors 7B carried by autonomous vehicles 7. FIG. 6 illustrates the coupling condition of the hydraulic connectors 3A of the operating unit 3, with the hydraulic connectors 5A arranged on the inner side of the stationary structure 5.

With reference to FIGS. 5, 6, the two hydraulic connectors 5A arranged on the inner side of the stationary structure 5 are mounted by means of a float supporting device or first float supporting device F1 (which will be described in detail below) on a common support plate 10, which, in turn, is mounted above the stationary structure 5 by means of a float supporting device or second float supporting device F2 (which will also be described in detail below).

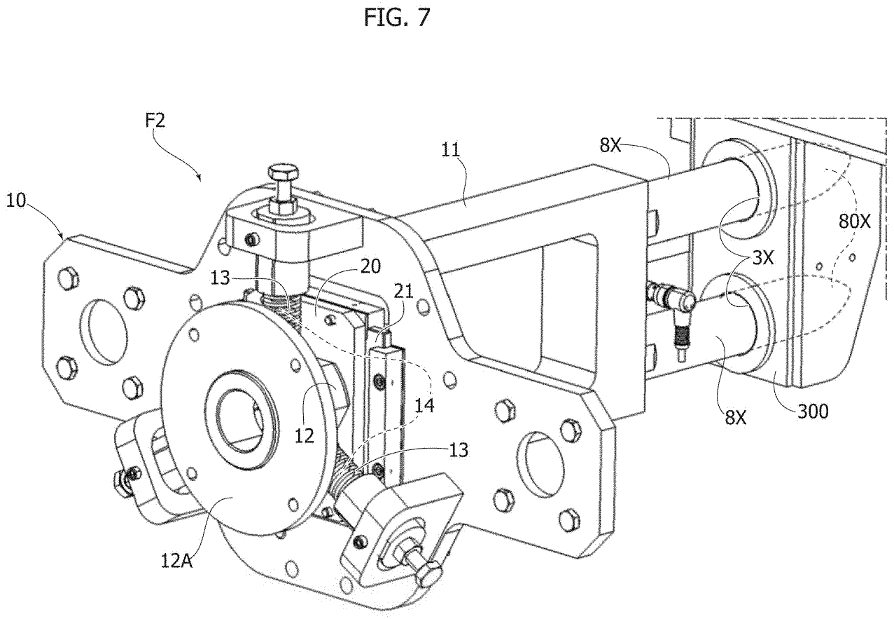

A support structure 11 (FIG. 7) is also anchored to a floating support, for example the support plate 10, which supports the two centering pins 8X with tapered heads 80X, with a conical shape, or with an ogive shape (see FIG. 7).

With reference to FIG. 7, by means of the float supporting device or second float supporting device F2, the plate 10, which carries the two hydraulic connectors 5A, is mounted floating on a core 12 consisting of a cylindrical body having a disc flange 12A screwed to the stationary structure 5.

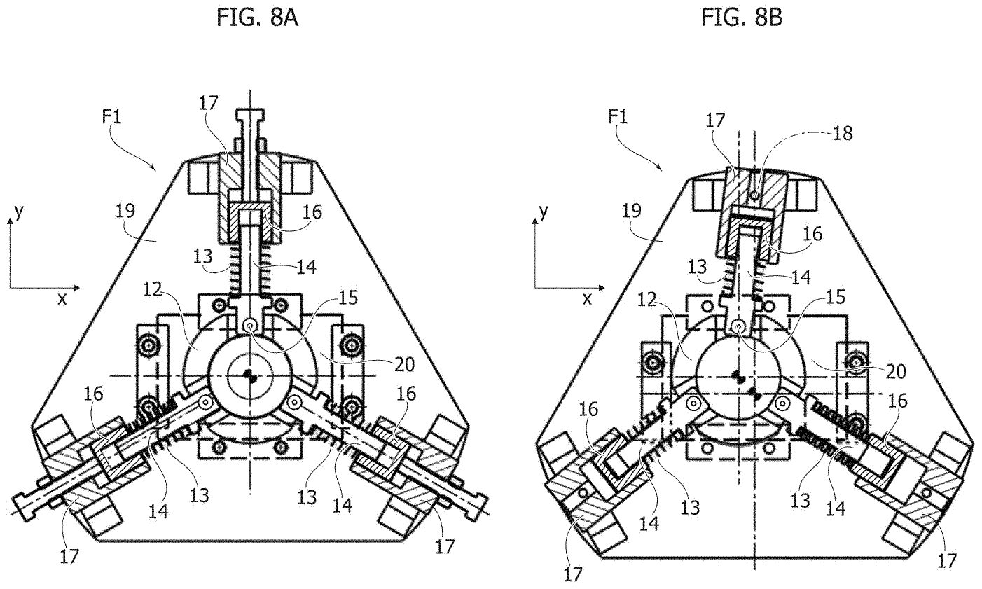

As can be seen in detail in FIGS. 8A, 8B, the float supporting device or first float supporting device F1 constituted by the support plate 10 is mounted on the core 12 by means of a plurality of helical springs 13 angularly spaced apart and arranged radially around the core 12.

Each helical spring 13 is mounted coaxially to the outside of a guide rod 14, which has one end pivotally connected at 15 to the body of the core 12, and the opposite end slidably mounted within a first cylinder 16, which is, in turn, slidably mounted inside a second cylinder 17 pivotally connected at 18 (FIG. 8B) to the structure of the support, which is thus pivotally mounted on the core 12. In the case of the float supporting device F2, the pivoting support is the aforesaid support plate 10, which, in turn, supports the two hydraulic connectors 5A.

The float supporting device F1 has an identical structure as the float supporting device F2. In this case, the pivoting support consists of a support plate 19, which is thus supported in a pivoting manner on the common support plate 10 (see also FIG. 6).

In each of the two pivoting float supporting devices F1, F2, the pivoting plate (support plate 19 or plate 10, respectively) is constrained to only move in a first direction x and in a second direction y orthogonal to each other and also orthogonal to a third direction z, which is the axial coupling direction of the hydraulic connectors (see FIG. 6). This result is obtained in that the pivoting plate (support plate 19 and 10, respectively) is mounted on the main support including the core 12 by means of a pair of slides 20, 21 orthogonal to each other and arranged in succession on each other (see in particular FIG. 7).

As can be seen, due to the effect of the structure described above, each of the float supporting devices F1, F2 leaves the respective support plate 19 and 10 free to move in the two directions x and y moving parallel to itself. The function of the helical springs 13 (in the example three springs are provided) is to tend to bring the pivoting element back to a neutral central position.

FIG. 8A shows the float supporting device F1 in the rest condition, wherein the pivoting support plate 19 is in its neutral position with respect to the central core 12 fixed to the stationary structure 5. FIG. 8B shows the float supporting device F1 in a condition wherein a relative movement of the pivoting support plate 19 with respect to the core 12 has occurred, both in the x direction and in the y direction, which causes an oscillation of the guide rods 14 and a compression of the helical springs 13, which thus tend to return the device to the neutral position.

Thanks to the float supporting device F2, the support plate 10 carrying the two hydraulic connectors 5A arranged on the inner side of the stationary structure 5 is able to float moving both in the x direction and in the y direction. In this way, this support plate 10 is able to accommodate any adjustment movements that occur following the engagement of the two centering pins 8X, which are carried by the support plate 10, within the centering bushings 3X. When the robot carries the operating unit 3 into the position predisposed for refilling, which is strictly predetermined, an electronic controller of the robot is, therefore, able to ensure that the centering bushings 3X are arranged in a required position in a precise manner Once this position has been reached, the robot commands a forward movement of the operating unit 3 in the z direction, so as to engage the centering bushings 3X around the centering pins 8X. If the centering pins 8X are not precisely in the required position, the engagement of their tapered heads 80X within the centering bushings 3X causes a flotation of the entire equipment carried by the support plate 10 along the x and y directions, thanks to the floating support device F2.

As indicated above, each of the two hydraulic connectors 5A arranged on the inner side of the stationary structure is carried on the common support plate 10 by means of the float supporting device F2. Compared to the float supporting device F2, the float supporting device F1 is designed to also allow a limited axial movement, in the z direction, to the respective hydraulic connector 5A with respect to the common support plate 10.

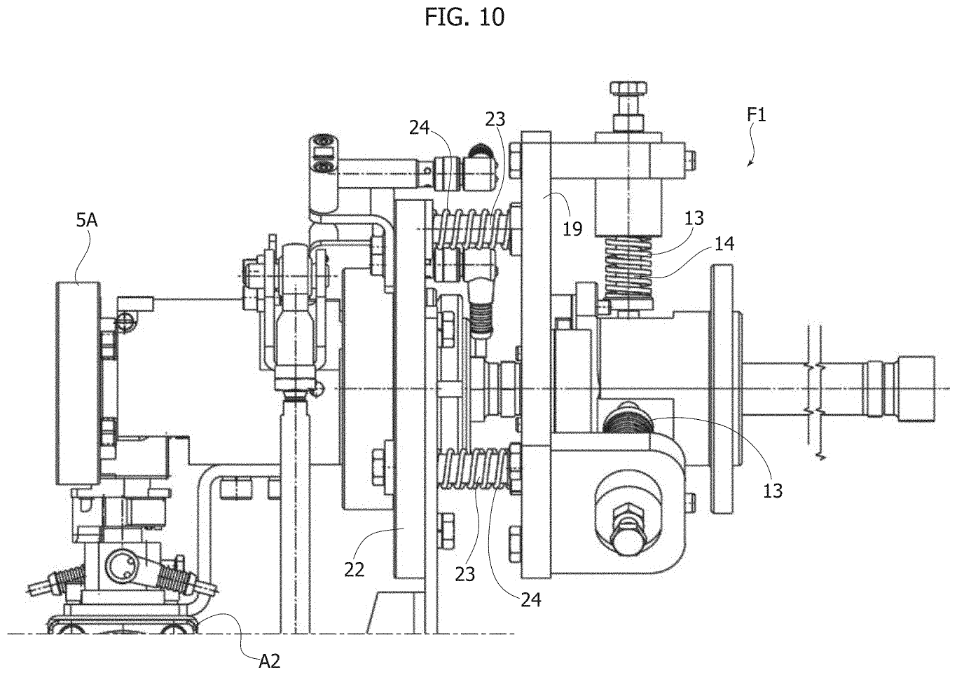

To this end, each of the hydraulic connectors 5A is carried by a disc 22 which is supported on the pivoting support plate 19 (i.e., the floating support) so as to be able to perform limited movements in the axial coupling direction z of the hydraulic connectors 5A. To this end, in the illustrated example (see FIGS. 6, 9A, 9B and 10), the disc 22 is mounted axially slidable with respect to the plate 19, facing it by means of a plurality of guide rods 23 distributed angularly around the central axis of the disc 22. Coaxially mounted helical springs 24 are mounted around said guide rods 23, tending to recall the disc 22 towards a neutral position. Thanks to the arrangement described above, each of the two hydraulic connectors 5A is free not only to have limited movements in the x and y directions (allowed by the helical springs 13), but also to have a limited backward movement in the axial direction z, or even small rotations around the x and y axes, corresponding to different degrees of compression of the helical springs 24 associated with the guide rods 23.

Thanks to the arrangement described above, when the robot 2 carries the operating unit 3 into the position of coupling with the refilling station 4, it commands an advancement of the operating unit 3 in the z direction, which firstly causes an engagement of the centering bushings 3X around the centering pins 8X. Following this engagement, any positioning inaccuracies of the hydraulic connectors 5A are accounted for thanks to the possibility of the support plate 10 (i.e., the floating support) of floating in the x and y directions. The further advancement of the operating unit 3 along the z direction controlled by the robot 2 causes engagement of the hydraulic connectors 3A of the operating unit 3 within the respective hydraulic connectors 5A on the inner side of the stationary structure 5. This engagement occurs following the application of a certain pressure in the axial direction by the robot, which is supported by the floating support devices F1, thanks to the possibility of the support plates 19 (i.e., the floating support) of yielding in the axial direction z, compressing the helical springs 24.

The hydraulic connectors 3A, 5A are of any type configured to couple one inside the other in order to give rise to a hydraulic communication. These connectors may be made in any known way. In the case of the example illustrated here, in accordance with a conventional technique, two electric actuators A1, A2 are associated with each of the hydraulic connectors 5A, which are activated to cause rotation about the main coupling axis of the hydraulic connectors of locking elements (not visible in the drawings), which ensure the sealing coupling of the hydraulic connectors. These constructive details are not illustrated here since, as said, they can be made in any known way, and since, furthermore, their elimination from the drawings makes them more readily and easily understood.

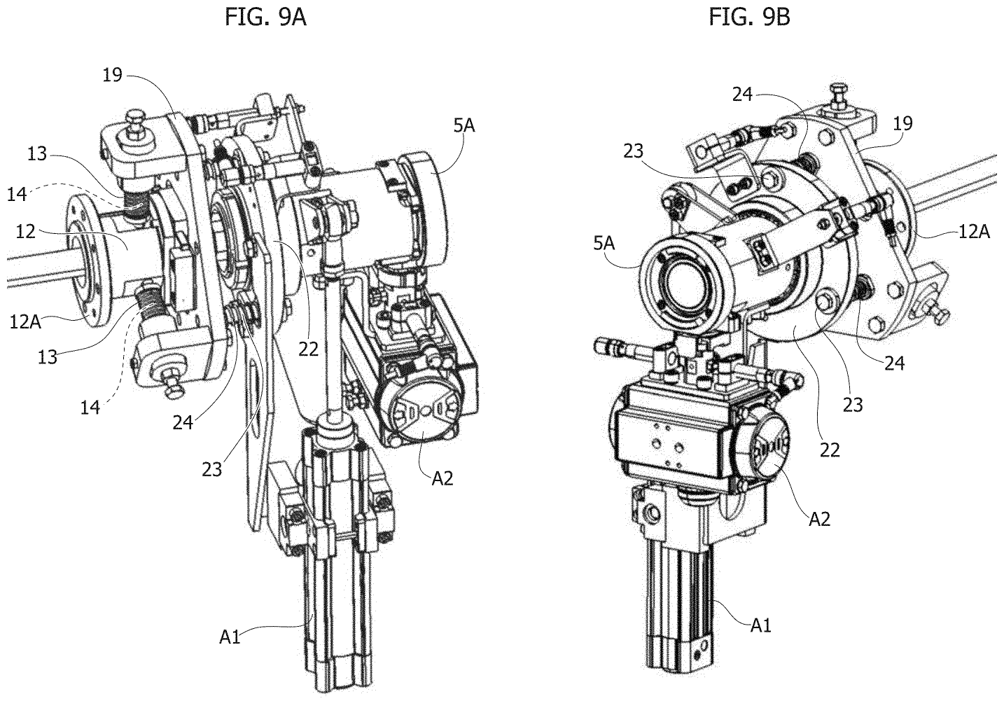

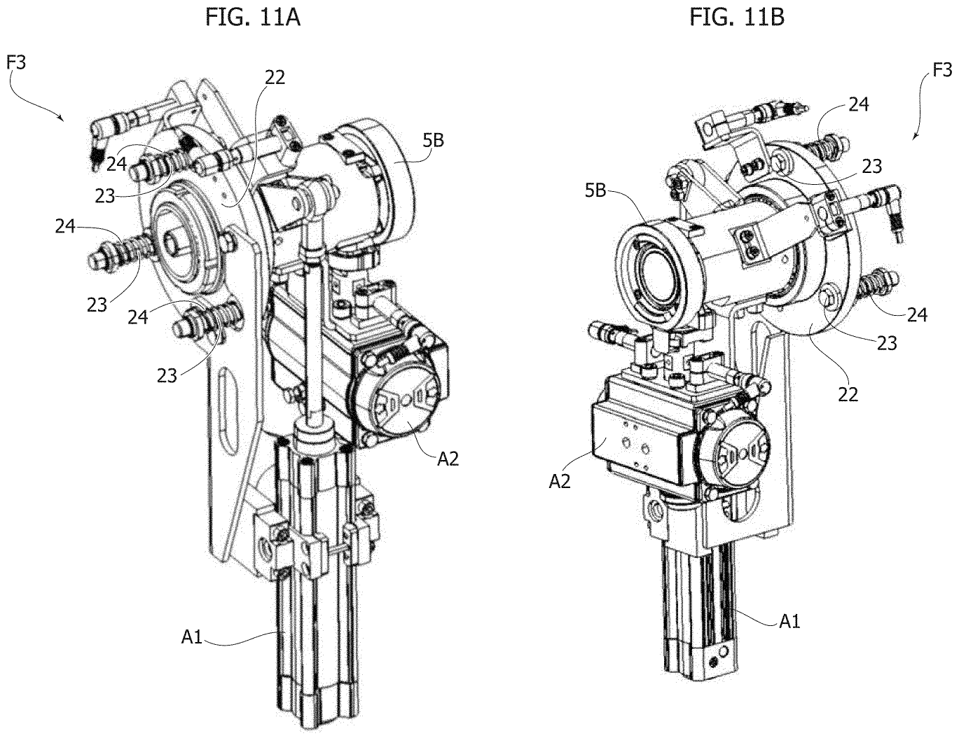

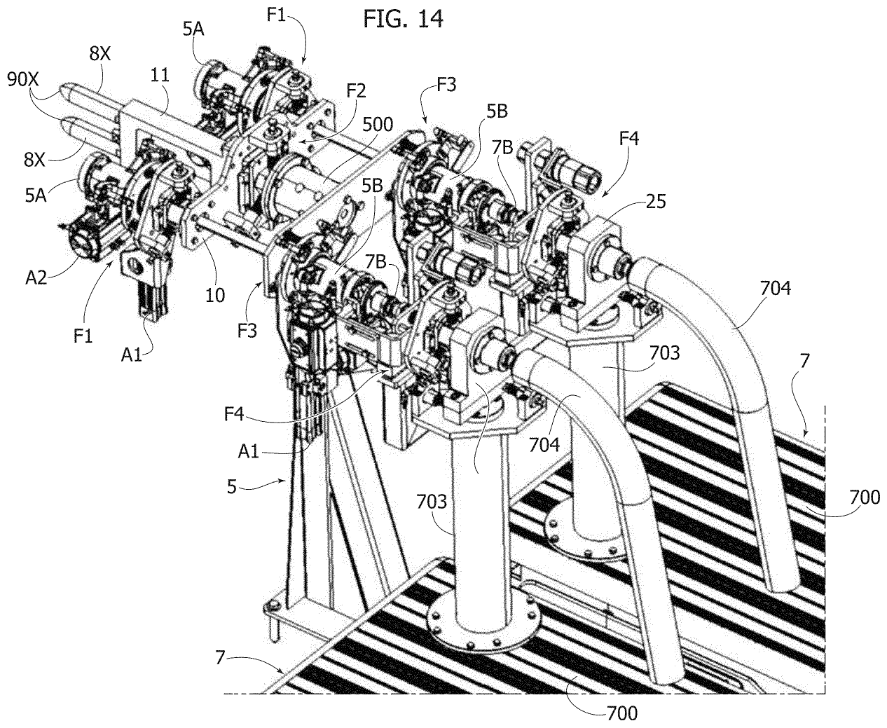

With reference now again to FIG. 5, as well as to FIG. 14, the hydraulic connectors 5B arranged on the outer side of the stationary structure 5 are carried on the stationary structure by means of float supporting devices or a third float supporting devices F3, which only allow a limited axial movement in the direction z and small oscillations around the directions x and y to the respective hydraulic connector 5B. This result is obtained with a structure entirely identical to that described with reference to the support of the disc 22 by means of the guide rods 23 and the helical springs 24 (FIGS. 9A, 9B). The floating support device F3 is illustrated in FIGS. 11A, 11B. In these Figures, the parts common to those of FIGS. 9A and 9B are indicated by the same reference numbers. Also in this case, the hydraulic connectors 5B are associated with electric actuators A1, A2 to control the rotation of sealed locking elements of the coupling between the hydraulic connectors 5B carried on the outer side of the stationary structure 5 and the hydraulic connectors 7B carried by the autonomous vehicles 7.

Thanks to the float supporting devices F3, the two hydraulic connectors 5B carried on the outer side of the stationary structure 5 are able to absorb the axial thrust exerted by the hydraulic connectors 7B carried by the autonomous vehicles 7 when they advance towards the coupling position of the aforesaid hydraulic connectors.

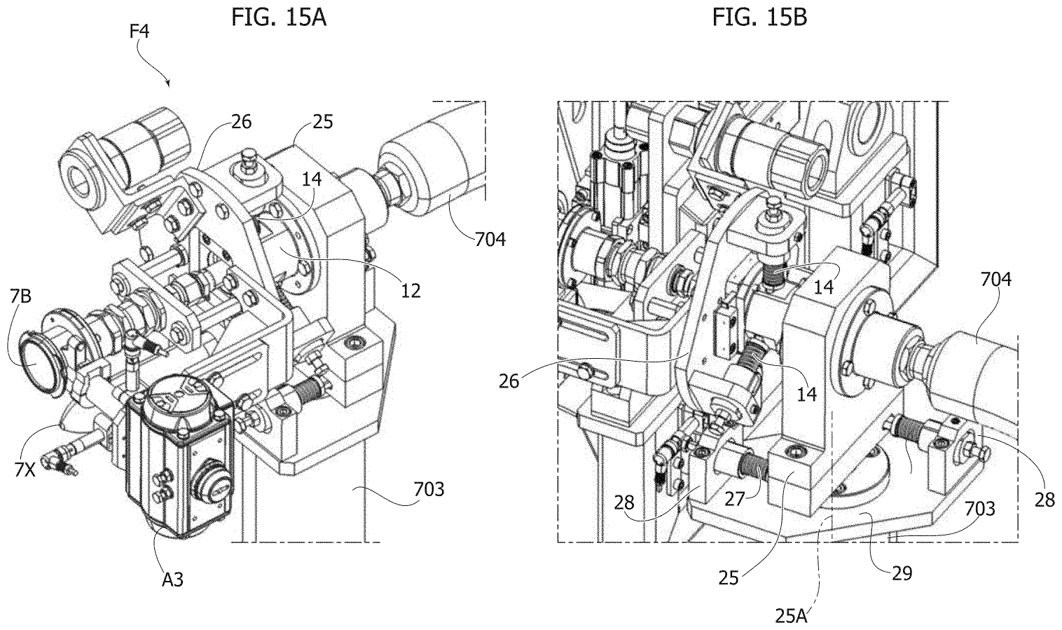

With reference now to FIGS. 14 and 15A, 15B, the two hydraulic connectors 7B carried by the two autonomous vehicles 7 are supported by supports 25 (or main supports) mounted on the upper ends of the uprights 703 carried by the bodies 700 of the two vehicles 7. Each of the hydraulic connectors 7B is carried by the respective support 25 by means of a floating support device or fourth floating support device F4, which is structurally and functionally identical to the float supporting device F2. In particular, each hydraulic connector 7B is carried by a support plate 26 (i.e., a floating support), which is free to have small displacements in the x direction and in the y direction with respect to the respective support 25. To this end, in a similar way to what has been described with reference to the device F2, the plate 26 is mounted by means of a succession of two orthogonal slides above the cylindrical core 12 projecting from the support 25. Furthermore, the support plate 26 is biased towards a neutral position by three angularly equidistant helical springs, also indicated by 14, in a completely identical way to that described with reference to FIGS. 8A, 8B.

With reference to FIG. 15A, each hydraulic connector 7B is also provided with an actuator A3 configured to control a mobile element (not illustrated), which secures the connector 7B in the condition of sealed coupling with the respective hydraulic connector 5B.

Again with reference to FIGS. 15A, 15B, in the case of the float supporting device F4, a further degree of freedom is provided, since each support 25 is, in turn, mounted on the top of the respective upright 703 in a rotatable way around a vertical axis 25A, parallel to the y direction. The support 25, and consequently the respective hydraulic connector 7B, is therefore capable of performing small oscillating movements around the vertical axis 25A, which are opposed by two helical springs 27 interposed between the body of the support 25 and two brackets 28 fixed on a top plate 29 of the upright 703.

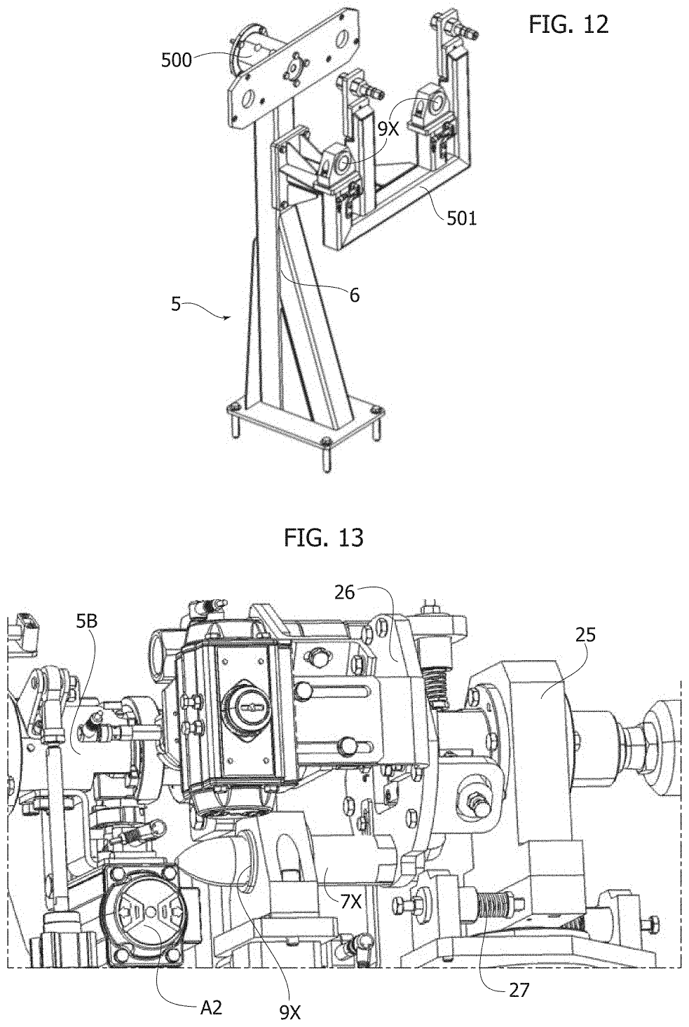

FIG. 12 of the attached drawings shows the frame of the stationary structure 5 in the case of the embodiment illustrated here. This frame includes the upright 6 secured to the floor which, at its upper end, supports a cylindrical body 500 facing an inside of the stationary structure to which the float supporting device F2 is connected (see FIG. 14). On the opposite side, at a lower height than the cylindrical body 500, a frame 501 protrudes from the upright 6, said frame bearing two centering bushings 9X configured to each receive a centering member, for example centering pin 7X, with a tapered front head, of conical or ogive conformation (clearly visible in FIG. 13 and only partially in FIG. 15A).

Thanks to the arrangement described above, the autonomous vehicles 7 are able to move to positions adjacent to the outer side of the stationary structure 5 and to advance until the centering pins 7X are engaged in the centering bushings 9X arranged on the outer side of the stationary structure 5.

While the electronic control of the robot 2 ensures that the operating unit 3 can precisely position itself in the coupling position with the inner side of the stationary structure 5, the control of the autonomous vehicles 7 does not allow a very high precision in the position of such vehicles. It is, therefore, possible that the hydraulic connectors 7B are in a slightly offset position, or even in inclined directions, with respect to the axes of the hydraulic connectors 5B arranged on the outer side of the stationary structure 5. When, following the advancement of the two vehicles 7 towards the stationary structure 5, the engagement of the centering pins 7X in the centering bushings 9X is obtained, this engagement causes an adjustment movement of the hydraulic connectors 7B arranged on the vehicles, which is allowed by the respective floating support device F4. The possibility of rotation of the support 25 around the vertical axis also allows accommodation of a possible small inclination of the axis of the hydraulic connector 7B with respect to the axis of the hydraulic connector 5B intended to be coupled therewith. The axial thrust exerted by the vehicles 7 against the hydraulic connectors 5B arranged on the outer side of the stationary structure, necessary to obtain the complete coupling between the hydraulic connectors 7B and 5B, is absorbed by the floating support devices F3 associated with the hydraulic connectors 5B (FIG. 14).

Of course, without prejudice to the principle of the invention, the details of construction and the embodiments may vary widely with respect to those described and illustrated purely by way of example, without departing from the scope of the present invention.

In particular, it is evident that although the illustrated example refers to the case of an operating unit 3 designed to dispense a two-component adhesive, it is entirely possible to provide an operating unit equipped with a single fluid accumulator containing a single mono-component fluid, in which case a single hydraulic connector 3A is provided on the operating unit 3, a single hydraulic connector 5A is provided on the inner side of the stationary structure 5; a single hydraulic connector 5B is provided on the outer side of the stationary structure 5, and the cell 1 is served by a single autonomous vehicle 7 equipped with a single hydraulic connector 7B communicating with a single reservoir 701 of fluid.

It is clear that although the illustrated example refers to the case of an operating unit carried by a robot, nothing excludes that the operating unit 3 may be carried by any different type of machine. Furthermore, the refilling reservoir 701 could also not be carried by an autonomous vehicle, but by any other device or transport system, even manually operated.

Finally, the floating support device used in the docking system of the invention, in any of the embodiments represented by the devices F1, F2, F3 and F4, can be applied in any other system wherein a coupling between connectors is provided, and wherein it is necessary to ensure a certain degree of freedom of movement of one hydraulic connector with respect to the other in order to ensure correct coupling even when the structures that carry the two hydraulic connectors are not in a suitable position to obtain a correct coupling. The structure and configuration of the floating support device therefore constitutes an invention in itself.

Finally it is clear that the aforesaid stationary intermediate structure could be omitted, and a docking maneuver with direct coupling between the hydraulic connectors carried by the first operating unit 3 and the second mobile service unit can be provided.

1. A docking system including a first operating unit (3) carrying one or more hydraulic connectors (3A), and at least one second mobile service unit (7), carrying one or more hydraulic connectors (7B) which can be coupled directly or indirectly with the one or more hydraulic connectors (3A) of the first operating unit,
wherein at least one of said one or more hydraulic connectors (3A, 7B) is carried by the respective unit (3,7) by a floating support (19, 10, 26), which is mounted on the respective unit by a float supporting device (F1-F4) configured to allow a floating movement of said floating support (19, 10, 26), so that said floating support is free to move relative to the respective unit along first and second directions (x, y), which are orthogonal to each other and which are also orthogonal to an axial coupling direction (z) of the one or more hydraulic connectors (3A, 7B),
wherein a respective centering member (3X, 7X) is associated with said floating support (19, 10, 26) of one of said units (3, 7), said centering member being configured to be coupled with a cooperating centering member (3X, 7X) directly or indirectly associated with the other of said units,
in such a way that, in a docking condition of the first operating unit (3) with the second mobile service unit (7) coupling between said centering members (3X, 7X) causes a movement of said floating support (19, 10, 26) to a position that corresponds to at correct coupling position of said one or more hydraulic connectors (3A, 7B),
wherein said floating support (19, 10, 26) is movably mounted relative to a main support (12, 25) along said first and second directions (x, y), and
wherein said floating support (19, 10, 26) is elastically biased towards a neutral position by means of a plurality of helical springs (13) mutually angularly spaced apart and arranged radially around said main support (12, 25), each helical spring (13) having a radially inner end associated with said main support (12, 25) and a radially outer end associated with said floating support (19, 10, 26).

2. The docking system according to claim 1, characterized in that each of said helical springs (13) is mounted coaxially around a guide rod (14), which has one end pivotally connected to either said main support (12) or said floating support (19, 10, 26), and the other end slidably mounted within a cylinder (17) pivotally connected to the other one of said main support (12, 25) and said floating support (19, 10, 26).

3. The docking system according to claim 2, characterized in that the one or more hydraulic connectors (5A, 7B) carried by said floating support (19, 26) is slidably mounted with respect to the floating support (19, 26) in the aforesaid axial coupling direction (z), and one or more helical springs (24) are provided to counteract the axial movement of the one or more hydraulic connectors (5A, 7B) with respect to the floating support (19, 26).

4. The docking system according to claim 3, characterized in that the one or more hydraulic connectors (5A, 7B) carried by the floating support (19, 26) is slidably mounted with respect to the floating support (19, 26) in the axial coupling direction (z) by a plurality of guide rods (23) angularly distributed around the axial coupling direction (z), said helical springs (24) are configured to counteract the axial movement of the hydraulic connector (5A, 7B) with respect to the floating support (19; 26), each helical spring (24) associated with one of the plurality of respective guide rods (23), so that the hydraulic connector (5A, 7B) is also free to have an oscillation movement with respect to said floating support (19, 26) around said first and second directions (x, y); the oscillation movement causes a different degree of compression of said helical springs (24) associated with said guide rods (23).

5. The docking system according to claim 4, characterized in that the main support (25) is mounted on the respective second mobile service unit (7), the main support (25) rotatable around a vertical axis (25A) parallel with the second direction (y), against the action of at least two contrasting helical springs (27).

6. The docking system according to claim 1 further comprising a stationary intermediate structure (5) configured for docking of said first operating unit (3) with said second mobile service unit (7),
wherein said stationary intermediate structure (5) carries, on a first side thereof, at least one hydraulic connector (5A) configured to couple with a respective one of the one or more hydraulic connectors (3A) of the first operating unit (3),
wherein said stationary intermediate structure (5) carries, on a second side, at least one hydraulic connector (5B) configured to couple with a respective one of the one or more hydraulic connectors (7B) of the second mobile service unit (7), and
wherein the hydraulic connectors (5A, 5B) respectively provided on said first side or said second side of said stationary intermediate structure (5) are in hydraulic communication with each other.

7. The docking system according to claim 6, characterized in that on said first side of the stationary intermediate structure (5), said at least one hydraulic connector (5A) is mounted on the stationary intermediate structure (5) by said float supporting device (F1, F2).

8. The docking system according to claim 6, wherein on said first side of the stationary intermediate structure (5), the at least one hydraulic connector (5A) comprises two first hydraulic connectors (5A) configured for independently supplying two different fluids, the two first hydraulic connectors are each carried by a first float supporting device (F1) that is connected to a common support plate (10), the common support plate (10) is mounted on said stationary intermediate structure (5) by a second float supporting device (F2).

9. The docking system according to claim 8, wherein each of said first float supporting devices (F1) further comprises a disc (22) configured to be free to move both in said first and second directions (x, y) and in said axial coupling direction (z).

10. The docking system according to claim 8, wherein said second float supporting device (F2) further includes the common support plate (10) configured to be free to move only in said first and second directions (x, y).

11. The docking system according to claim 8, wherein the one or more hydraulic connectors (3A) of the operating unit (3) comprise two hydraulic connectors (3A), characterized in that said common support plate (10), on which the first two first hydraulic connectors (5A) are mounted by means of said first float supporting devices (F1), also carries at least two centering pins (8X) with tapered heads (80X) protruding from said first side of the stationary intermediate structure (5) and configured to be received within cooperating centering bushings (3X) carried by said first operating unit (3), in a docking condition wherein said two first hydraulic connectors (5A) carried by the stationary intermediate structure (5) are coupled with the two hydraulic connectors (3A) carried by the first operating unit (3).

12. The docking system according to claim 86, wherein the at least one hydraulic connector (5B) comprises two second hydraulic connectors (5B) provided on said second side of the stationary intermediate structure (5), communicating hydraulically with said two first hydraulic connectors (5A), which are arranged on the first side of the stationary intermediate structure (5), and
wherein said two second hydraulic connectors (5B) are carried on said stationary intermediate structure (5) by a third float supporting device (F3) configured to only enable a movement in said axial coupling direction (z).

13. The docking system according to claim 12, wherein the at least one second mobile service unit (7) comprises two second mobile service units (7) and the one or more hydraulic connectors (7B) comprise two hydraulic connectors (7B), each of the two second mobile service units (7) carrying one of the two hydraulic connectors (7B) configured to couple with a respective one said two second hydraulic connectors (5B) carried on said second side of the stationary intermediate structure (5), each of said two hydraulic connectors (7B) carried by the respective second mobile service unit (7) being carried by a fourth float supporting device (F4) mounted on the respective second mobile service unit (7) and configured to allow a movement both in said first and second directions (x, y) and in said axial coupling direction (z) with respect to theft main support (25), the main support (25) is rotatably mounted on the respective second mobile service unit (7) and configured to rotate around a vertical axis (25A), against the action of at least two contrast helical springs (27).

14. The docking system according to claim 13, wherein said centering member (7X) comprises at least one centering pin (7X), wherein said fourth float supporting device (F4) carried by each of said two second mobile service units (7) also carries the at least one centering pin (7X) with a tapered head protruding from the respective second mobile service unit (7) and is configured to be received within a cooperating centering bushing (9X) carried by said stationary intermediate structure (5) on said second side.

15. The docking system according to claim 1, wherein the first operating unit (3) carries a fluid accumulator, and said at least one second mobile service unit (7) is provided with a reservoir (701) configured to refill said fluid accumulator,
wherein said first operating unit (3) is an operating unit (3) for dispensing an adhesive sealant fluid, and is carried by a manipulator robot (2), and
wherein said at least one second mobile service unit (7) is an autonomous vehicle comprising one of an automated guided vehicle or an autonomous mobile robot carrying the reservoir, configured to refill said fluid accumulator.

16. The docking system according to claim 1, wherein the floating support (19, 10, 26) is movably mounted with respect to the main support (12) along said first and second directions (x, y) by two respective slides (20, 21) oriented orthogonal to each other and mounted in succession on one another.

17. The docking system according to claim 4 further comprising a stationary intermediate structure (5) configured for docking of said first operating unit (3) with said second mobile service unit (7),
wherein said stationary intermediate structure (5) carries, on a first side thereof, at least one hydraulic connector (5A) configured to couple with a respective one of the one or more hydraulic connectors (3A) of the first operating unit (3),
wherein said stationary intermediate structure (5) carries, on a second side, at least one hydraulic connector (5B) configured to couple with a respective one of the one or more hydraulic connectors (7B) of the second mobile service unit (7), and
wherein the hydraulic connectors (5A, 5B) respectively provided on said first side or said second side of said stationary intermediate structure (5) are in hydraulic communication with each other.
